(19) United States
(12) Patent Application Publication
(10) Pub. No.: US 2026/0170466 A1
(43) Pub. Date: Jun. 18, 2026

(54) WARRANTY AND SERVICE CONTRACT MANAGEMENT

(71) Applicant: SCHNEIDER ELECTRIC IT CORPORATION, Foxboro, MA (US)

(72) Inventors: Bence Sólyom, Horsens (DK); Florent Bouhey, Marcilloles (FR); Ioana Octavia Grigore, Horsens (DK)

(21) Appl. No.: 18/980,150

(22) Filed: Dec. 13, 2024

(51) Int. Cl. G06Q 10/20; G06F 3/0482; G06F 3/0484

(52) U.S. Cl. CPC G06Q 10/20; G06F 3/0482; G06F 3/0484

(57) ABSTRACT

A method of managing warranties and service contracts is presented. The method includes identifying one or more devices; providing, via a user interface, a list of the one or more devices; responsive to receiving a request to filter the list, providing a portion of the list limited to a subset of the one or more devices, the subset corresponding to the request to filter the list; and providing, via the user interface, a respective maintenance agreement status associated with each device of the one or more devices, the respective maintenance agreement status being based on whether a respective device of the one or more devices is associated with a maintenance agreement.

### BACKGROUND

### 1. Field of the Disclosure

At least one example in accordance with the present disclosure relates generally to managing warranty and service contracts.

### 2. Discussion of Related Art

Companies often own many devices that may be subject to different warranties and different service contracts. These companies must maintain their warranty and service contract records themselves.

### SUMMARY

According to at least one aspect of the present disclosure, a system for managing maintenance agreements is presented, comprising: a management module configured to: identify one or more devices, retrieve maintenance agreement information from a database, provide, via a user interface, a list of the one or more devices, and provide, via the user interface, a respective maintenance agreement status associated with each device of the one or more devices, the respective maintenance agreement status being based the maintenance agreement information and on whether a respective device of the one or more devices is associated with a maintenance agreement.

In some examples, the management module is configured to provide, via the user interface, one or more filter options to the user, and, responsive to receiving a request to filter the list, providing a portion of the list limited to a subset of the one or more devices, the subset corresponding to the request to filter the list. In some examples, the management module is configured to provide analytic data via the user interface, the analytic data corresponding to the one or more devices and to the respective maintenance agreement status of each device. In some examples, the analytic data includes at least three classifications including a first classification of devices covered by a maintenance agreement expiring in a predetermined number of days or more, a second classification of devices covered by a maintenance agreement expiring in less then the predetermined number of days, and a third classification of devices not covered by an active maintenance agreement. In some examples, the analytic data is displayed using at least a graph showing one or more respective visual representations of relative percentages of devices covered by the first classification, the second classification, and the third classification. In some examples, each respective visual representation of the one or more respective visual representations is configured to, when interacted with by a user, display a numeric representation of a respective percentage corresponding to the respective visual representation. In some examples, the system further comprises a data aggregator configured to receive one or more identities of one or more devices from a point-of-sale system, and to associate respective identities of the one or more devices with one or more maintenance agreements covering respective devices to which the one or more identities correspond. In some examples, the management module is further configured to receive requests from a user to store previously unobtained data in a database and, responsive to receiving the requests, to store at least a portion of the previously unobtained data.

According to at least one aspect of the present disclosure, a method of managing warranties and service contracts is presented, comprising: identifying one or more devices; providing, via a user interface, a list of the one or more devices; responsive to receiving a request to filter the list, providing a portion of the list limited to a subset of the one or more devices, the subset corresponding to the request to filter the list; and providing, via the user interface, a respective maintenance agreement status associated with each device of the one or more devices, the respective maintenance agreement status being based on whether a respective device of the one or more devices is associated with a maintenance agreement.

In some examples, the method further comprises providing, via the user interface, analytic data about the one or more devices. In some examples, the analytic data includes at least three classifications including a first classification, a second classification, and a third classification, the first classification corresponding to devices covered by a maintenance agreement expiring in a predetermined number of days or more, the second classification corresponding to devices covered by a maintenance agreement expiring in less than the predetermined number of days, and the third classification corresponding to devices not currently covered by an active maintenance agreement. In some examples, the analytic data is displayed using at least a graph showing one or more respective visual representations of relative percentages of the first classification, the second classification, and the third classification. In some examples, each respective visual representation of the one or more respective visual representations is configured to, when interacted with by a user, display a numeric representation of a respective percentage corresponding to the respective visual representation. In some examples, the maintenance agreement status includes at least one of an expiration date of at least one non-expired maintenance agreement associated with at least one device of the one or more devices, or an indication that no maintenance agreement applies to the at least one device. In some examples, providing the respective maintenance agreement status includes displaying, via the user interface, maintenance agreement statuses of the subset of the one or more devices responsive to receiving the request to filter the list. In some examples, identifying the one or more devices includes identifying the one or more devices at a point-of-sale system; and the method further comprises, responsive to identifying the one or more devices, associating the one or more devices with at least one maintenance agreement of the one or more maintenance agreements.

According to at least one aspect of the present disclosure, a non-transitory computer-readable medium is presented, containing thereon instructions for managing maintenance agreement data, the instructions, when executed, causing at least one processor to: identify one or more devices; display, via a user interface, a list of the one or more devices; display one or more filters; responsive to receiving a filter request based on the one or more filters, displaying a subset of the list on the user interface, the subset corresponding to the filter request; and display, via the user interface, a respective maintenance agreement status associated with each device of the one or more devices, the respective maintenance agreement status being based on whether a respective device of the one or more devices is associated with a maintenance agreement.

In some examples, the maintenance agreement status includes at least one of an expiration data of a non-expired maintenance agreement associated with at least one device of the one or more devices, or an indication that no maintenance agreement applies to the at least one device. In some examples, the instructions further cause the at least one processor to: identify the one or more devices at a point-of-sale; transmit at least one identity of the one or more devices to a database; associate the at least one identity of the one or more devices with the one or more maintenance agreements in the database or indicate that no maintenance agreement applies to the one or more devices corresponding to the at least one identity. In some examples, the instructions further cause the at least one processor to display, via the user interface, analytics corresponding the one or more devices and the one or more maintenance agreements, the analytics being displayed using at least a graph showing one or more respective visual representations of relative percentages of devices covered by a maintenance agreement expiring in a predetermined number of days or more, devices covered by a maintenance agreement expiring in less than the predetermined number of days, and devices not covered by an active maintenance agreement with respect to all devices of the one or more devices, and each respective visual representation of the one or more respective visual representations, responsive to being interacted with by a user, causes display of a numeric representation of a respective percentage corresponding to the respective visual representation.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates a system for managing maintenance agreements according to an example;

FIG. 2 illustrates a user interface according to an example;

FIG. 3 illustrates a user interface according to an example; and

FIG. 4 illustrates a process for managing maintenance agreements according to an example.

### DETAILED DESCRIPTION

Customers (be they a company, individual, or otherwise) traditionally have to maintain their warranty records themselves, individually and/or by using whatever in-house organizational means are available. Such means often include keeping paper records. This can be inconvenient and costly, as well as error prone, because such records can be lost, destroyed, forgotten, and so forth, effectively depriving the customer of the benefit of their warranties and service contracts. Also, as warranties are typically provided on a per device basis, and service contracts may have unique terms and conditions to them which can mean a given service contract applies only to a subset of devices (such as a class of device, a type of device, a group of devices purchased during a given period of time, and so forth), it can be difficult for the customer to identify which devices are covered by which warranties and contracts.

Aspects of the present disclosure relate to a system for managing all warranties and service contracts between a given customer and one or more vendors. For example, the systems and methods disclosed herein are capable of automatically determining the warranties and service contracts associated with various devices in use by the customer, including which devices are covered by which warranties and/or service contracts, as well as providing the status of the warranties and contracts, including time until expiration. Furthermore, the warranties and service contracts can be automatically added to a database for the customer at the time of sale, and the database can include useful options enabling the customer to view and use their warranties and service contracts.

In the context of this application, the term “vendor” may refer to the manufacturer and/or seller of the good, as well as encompassing its ordinary meaning. The term “maintenance agreement” may encompass both warranties and service agreements.

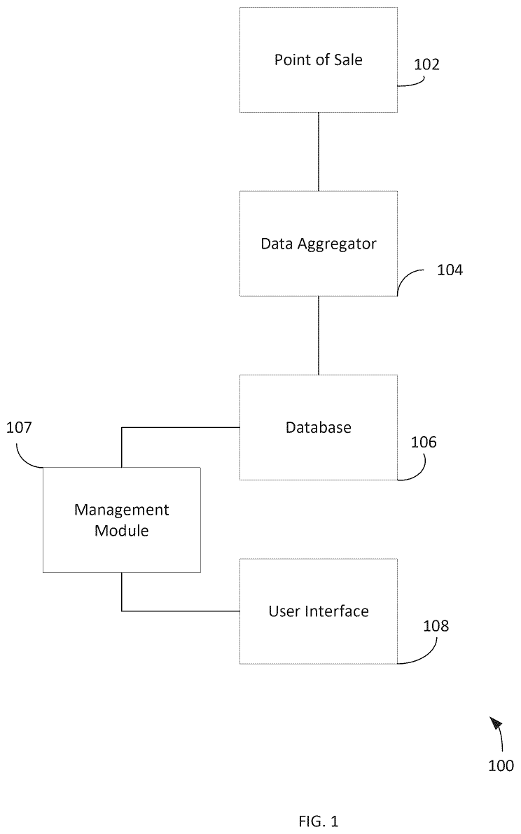

FIG. 1 illustrates a block-diagram of a system 100 for providing warranty and service contract information according to an example. The system 100 may acquire warranty and service contract information at a point-of-sale and then display the warranty and service contract to the customer using a user interface.

The system 100 includes a point-of-sale system 102, a data aggregator 104, a database 106, and a user interface 108. The point-of-sale system 102 is communicatively coupled to the data aggregator 104. The data aggregator 104 is communicatively coupled to the database 106. The database 106 is communicatively coupled to a management module 107, and the management module 107 is communicatively coupled to the user interface 108. In addition to being communicatively coupled (e.g., in communication with each other), the at least some of the above members of the system 100 may also be physically coupled to at least some other members of the system 100. However, physical coupling is not a requirement.

The point-of-sale system 102 is the system used to make and log a sale of a device and/or warranty and/or service contract to a customer. For example, the point-of-sale system 102 may be a sales register (such as a cash register), a website for receiving and processing customer orders, a customer service desk, and so forth. Preferentially, the point-of-sale system 102 incorporates a computer system of any type that is capable of logging the sale and information related to the sale. When a sale is made and/or logged at the point-of-sale system 102, the sale may be transmitted to the data aggregator 104.

The data aggregator 104 is any device, typically a computer system, that receives an indication that a sale has been made from the point-of-sale system 102, and records the sale in a database, such as the database 106. However, the data aggregator 104 may also associate the sale with applicable warranties and/or service contracts. For example, if the device sold was a uninterruptible power supply (UPS) system, the data aggregator 104 can recognize the device as a UPS, including detailed information such as make, model, serial number, and so forth. The data aggregator 104 can record such information, and can determine whether the vendor offers or provides a warranty on the device. The data aggregator 104 may then automatically populate the database 106 with the warranty information, including the expiration data of the warranty.

Likewise, with service contracts, the data aggregator 104 may determine if a given device is covered by a given service contract, and may automatically incorporate the information about the service contract into the database 106.

In cases where multiple warranties and/or service contracts cover a single device, the data aggregator 104 may associate the device with each and every such warranty or contract that applies to it. That is, in some examples, the data aggregator 104 populates the database 106 with every associated warranty and service contract that applies to a given device.

The database 106 is a database that may contain the device information, including serial number, make, model, location, status, and so forth. The database 106 includes information about the warranties and service contracts associated with the device. The database 106 may also include other information, such as a unique identifier of the device, who made the sale, where the sale was made, and so forth. The database 106 may also include information as to whether any given data was populated automatically or manually.

The management module 107 is a system for managing the database 106 and providing an interface between the database 106 and the user interface 108. The management module 107 may be a server or distributed server (on a cloud infrastructure), and may contain software programs that permit the user interface 108 to access the database 106. The management module 107 may access the database 106 and information contained in the database 106. The management module 107 may receive requests from the user interface 108 and may then provide data from the database corresponding to the requests from the user interface 108 to the user interface 108. The management module 107 may provide the user interface 108 to the user-that is, the management module 107 may, for example, host an application that the user may access via the user interface 108. When the user accesses said application, the management module 107 may provide data to the user that permits the user to view the user interface 108 and to select among the available options presented by the management module 107. Accordingly, when the user selects to filter data in the database 106, the management module 107 may perform the actual filtering and then provide the results to the user (e.g., via the user interface 108). Furthermore, in some examples, the management module 107 may be configured to also provide the user (e.g., via the user interface 108) with the option to upload data not previously acquired (e.g., data not previously acquired by the point-of-sale system 102), and to store that data in the database 106. In some examples, where data submitted by the user conflicts with data previously acquired (e.g., by the point-of-sale system 102), the management module 107 may discard the conflicting portion of the user data and/or reject all data that would modify any part of the already-collected data in the database 106. For example, data acquired via the data aggregator 104 may be “read-only,” and thus may not be modifiable by the user. In some examples, the data aggregator 104 may submit data, and the management module 107 may be configured to accept data submitted by the data aggregator 104, including overwriting previously acquired data and/or classifying previously acquired data as old and relegating it to historical records.

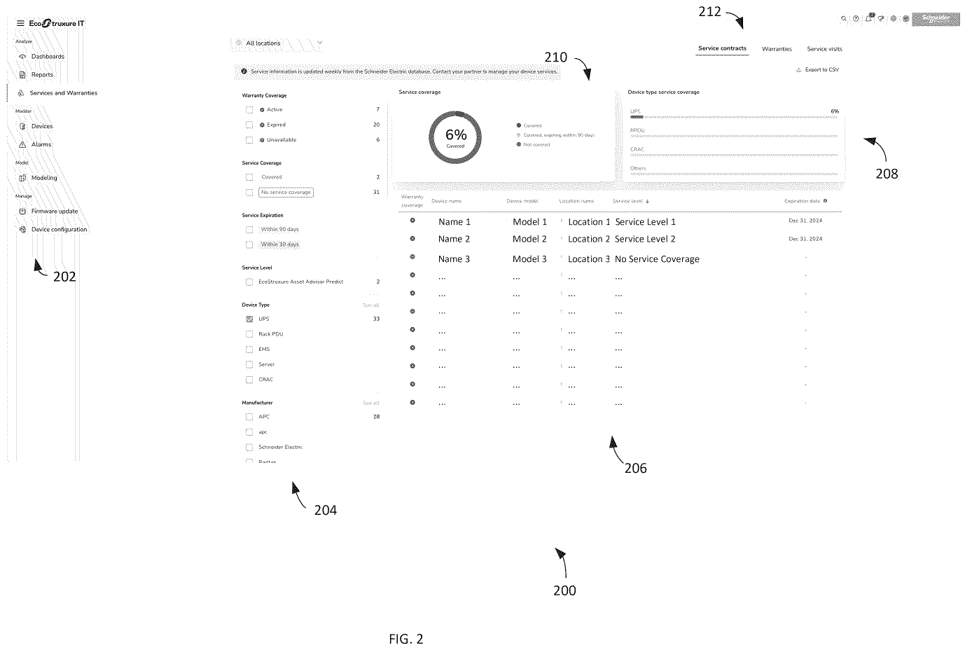

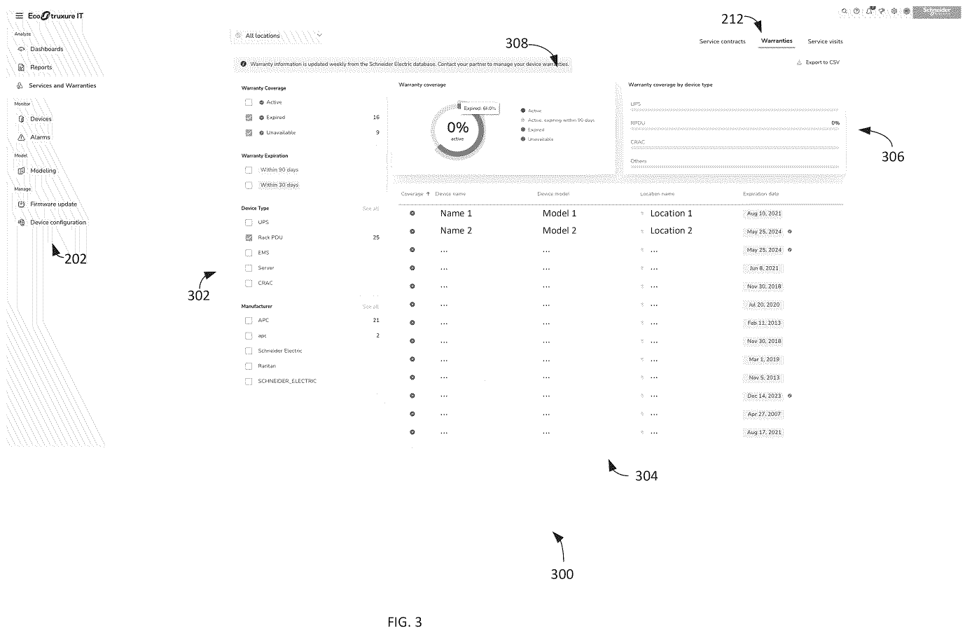

The user interface 108 is a system for accessing the database 106. Examples of user interfaces are provided below, with respect to FIGS. 2 and 3. In some examples, the user interface 108 can be accessed using a computer, such as a desktop, laptop, phone, pad, and so forth. The user interface 108 may, in some examples, be accessed via the internet or a similar telephonic connection. The user interface 108 may permit the customer (or any user) to select options for accessing and viewing warranty and service contract information for devices, classes or types of devices, subsets of devices, devices at a given location, devices with certain types of warranties, devices with warranties expiring relatively soon, and so forth. That is, the user interface 108 may allow the user to filter devices, warranties, and/or service contracts according to given criteria, or to view all devices, warranties, and/or service contracts by presenting the user with the options provided by the management module 107. That is, in some examples, the user interface 108 permits the user to access some or all functionalities of the management module 107.

In some examples, the data aggregator 104 and/or database 106 may be servers, and may be distributed, monolithic, or otherwise (e.g., may be cloud based or may be traditional servers).

FIG. 2 illustrates a user interface 200 according to an example. The user interface 200 displays information about service contracts for devices. The user interface 200 includes a dashboard 202, a filter menu 204, a device list 206, a first analytic display 208, a second analytic display 210, and a selection menu 212.

The dashboard 202 permits a user, such as the customer, to select between different potential services. As illustrated, in addition to warranty and contract service options, the user may also choose between reports, devices, alarms, and updates.

The filter menu 204 permits the user to filter the list of devices 206 according to selected criteria. As illustrated, the filter menu 204 has been used by the user to show only devices that match the UPS criterion. As a result, the device list 206 shows only UPS devices (and not alternatives, such as rack PDUs, servers, and so forth). However, multiple criteria may be selected if desired, and fields other than that of the device type may also be selected. For example, when multiple criteria are selected, then the devices displayed in the device list 206 are the subset of devices of all devices in the database which match all selected criteria. With respect to the fields selected, as illustrated, only the device type filter is being used in the filter menu 204, however other filter options exist. For example, a user may also filter by warranty coverage status (e.g., actively covered, expired, and/or data unavailable, as well as any other desirable status classification), service coverage (e.g., whether a service contract currently covers the device), the manufacturer (e.g., who built and/or made the device), the service level (e.g., the type of coverage), and so forth. In general, the filter menu 204 may present any options that correspond to information collected concerning the device. For example, other filter options could include make, model, physical location, location of sale, and so forth. Other options may include things like power consumption of the device, purchase price, and so forth.

The device list 206 shows the user those devices that match the user's filters, as selected in the filter menu 204. The device list 206 may have various columns showing data associated with the devices (for example, warranty coverage status, the device's name, model, location, service level, expiration date of the relevant service contract, and so forth). The device list 206 can display at least as much information as has been collected about a given device. The data contained on the device list 206 may be divided into columns, and the user may sort the columns by clocking the relevant column header. As illustrated, the device list 206 is sorted by service level, as indicated by the arrow next to the words “service level.”

The first analytic display 208 illustrates information about the dataset and/or the selected subset of devices. For example, as illustrated, the first analytic display 208 shows the percentage of devices of the selected UPS type that have service coverage.

The second analytic display 210 illustrates information about the dataset and/or the selected subset of devices. The particular method of displaying the information may differ compared to the first analytic display 208. For example, as illustrated, the second analytic display 210 displays service contract coverage information using a circular graph, while the first analytic display 208 uses a bar graph.

The selection menu 212 permits the user to navigate between different data focuses. For example, the selection menu 212 contains buttons allowing selection between service contracts and/or warranties (as well as service visits). The service contracts option permits the user to view information about service contracts, while the warranties option permits the user to view information about warranties. As mentioned above, when viewing devices using the service contract option, an indication of whether a device is covered by a warranty may also be provided.

FIG. 3 illustrates a user interface 300 according to an example. The user interface 300 shows information about warranties. The user interface 300 retains the dashboard 202 and selection menu 212 of FIG. 2. The user interface 300 also includes a filter menu 302, a device list 304, a first analytic display 306, and a second analytic display 308.

The filter menu 302 permits the user to filter the list of devices 304 according to selected criteria. As illustrated, the filter menu 302 has been used by the user to show only devices that match the rack PDU criterion. As a result, the device list 304 shows only rack PDU devices (and not alternatives, such as rack UPSs, servers, and so forth). However, multiple criteria may be selected if desired, and fields other than that of the device type may also be selected. For example, when multiple criteria are selected, then the devices displayed in the device list 304 are the subset of devices of all devices in the database which match all selected criteria. With respect to the fields selected, as illustrated, only the device type filter is being used in the filter menu 302, however other filter options exist. For example, a user may also filter by warranty coverage status (e.g., actively covered, expired, and/or data unavailable, and so forth), service coverage (e.g., whether a service contract currently covers the device), the manufacturer (e.g., who built and/or made the device), the service level (e.g., the type of coverage), and so forth. In general, the filter menu 302 may present any options that correspond to information collected concerning the device. For example, other filter options could include make, model, physical location, location of sale, and so forth. Other options may include things like power consumption of the device, purchase price, and so forth.

The device list 304 shows the user those devices that match the user's filters, as selected in the filter menu 302. The device list 304 may have various columns showing data associated with the devices (for example, warranty coverage status, the device's name, model, location, service level, expiration data of the relevant service contract, and so forth). The device list 304 can display at least as much information as has been collected about a given device. The data contained on the device list 304 may be divided into columns, and the user may sort the columns by clocking the relevant column header. As illustrated, the device list 304 is sorted by warranty coverage status, as indicated by the arrow next to the words “coverage.”

The first analytic display 306 illustrates information about the dataset and/or the selected subset of devices. For example, as illustrated, the first analytic display 306 shows the percentage of devices of the selected rack PDU type that have warranty coverage.

The second analytic display 308 illustrates information about the dataset and/or the selected subset of devices. The particular method of displaying the information may differ compared to the first analytic display 306. For example, as illustrated, the second analytic display 308 displays service coverage information using a circular graph, while the first analytic display 306 uses a bar graph.

With respect to the analytics displays 208, 210, 306, 308 of FIGS. 2 and 3, subcomponents of those displays may be interactable and may contain various data. In some examples, the analytic displays 208, 210 of FIG. 2 may indicate the relative percentages of the total devices or a subset of the devices that match a filter selection which are covered by a service contract expiring in a given number of days or more, the given number of days or less, or which are not currently covered by an active service contract. Likewise, the analytic displays 306, 308 of FIG. 3 may indicate the relative percentages of the total devices or a subset of devices that match a filter selection which are covered by a warranty expiring in a given number of days or more, the given number of days or less, or which are not currently covered by an active warranty.

The analytic displays may be interactable, as mentioned above. For example, the circle graph or bar graphs may be capable of being interacted with (for example, clicked as with a computer cursor), so that a numeric representation of the portion of the graph that was interacted with is displayed. For example, with reference to FIG. 2, the second analytic display 210 shows a circular graph with covered, covered (expiring within 90 days) and not covered classifications. Clicking on the portion of the graph that corresponds to covered devices (in the upper right, roughly, in the picture) may cause “6% Covered” to appear in the middle of the circle (though said data could also appear anywhere else on the screen. Of course, the 6% could be any number that corresponds to the percentage of devices matching the filter selection (or of the total devices) that are covered. Likewise, interacting with the bar graph in the first analytic display 208 may cause additional details to be displayed. For example, if the covered devices are 70% UPSs and 30% RPDUs, then such information could be displayed in a tooltip when interacting with (for example, mousing over) the portion of the graph corresponding to “covered” devices. Likewise, the same information could be displayed in the first analytic display 208, 306. For example, still with reference to FIG. 2, the bar graphs in the first analytic display 208 could be replaced with a display of the 70% UPS and 30% RPDU coverage (as in the example above) in graphical and/or text form. In some examples, a sublist of the list in the device list 206, 304 could be displayed which match the interacted with category in the second analytic display 210. For example, interacting with the “covered” portion of the graph in the second analytic display 210 may cause a list of covered devices from the devices currently displayed in the list display 206 to appear in the first analytic display 208.

Many iterations and potential interactions are possible, the above being examples. All such iterations and potential interactions are permissible with respect to the display of analytic data, including which types of data, the form of the data, and so forth, that is displayed in response to an interaction. Likewise, interactions may work both ways, such that interacting with an item in the first analytic display 208, 306 alters the second analytic display 210, 308, and so forth.

In general, when interacting with any element of the analytic displays 208, 210, 306, 308,

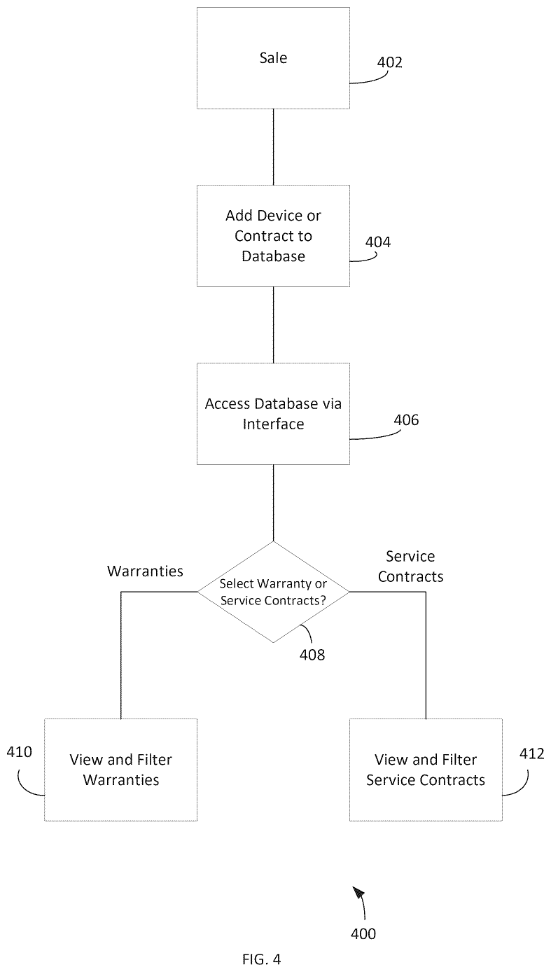

FIG. 4 illustrates a process 400 for providing a customer with warranty and service contract information about a given device or group of devices.

At act 402, a sale of a device or service contract is made by a vendor to a customer. During the sale, the point-of-sale system may record the sale, including such information as the identity of the device, for example, via an identifying number assigned to the device, a bar code, or other identifier. The point-of-sale system may upload the information related to the sale to a database or to a data aggregator. In the case of a service contract, details of the contract may be recorded and provided to the database or data aggregator. The process 400 may then continue to act 404.

At act 404, the information pertaining to the sale is consolidated in the database and associated with related information, such as related warranty and service contract information. For example, the data aggregator 104 of FIG. 1 may receive the sale information and recognize the device and customer, and then determine the warranty for the device and any relevant service contracts belonging to the customer. Likewise, if the sale was of a service contract, the data aggregator may determine the customer and relevant devices to which the service contract applies, and populate the database with that information. In general, the devices, warranties, service contracts, and respective expiration dates of the warranties and service contracts may be determined, along with any other data related to the devices and service contracts, associated, and stored in the database. The process 400 may then continue to act 406.

At act 406, a user, such as the customer, may access the database 406 via an interface, such as the user interfaces 200, 300 of FIGS. 2 and 3. The process 400 may then continue to act 408.

At act 408, a selection is made between viewing warranty or service contract data. For example, a user may select between viewing warranty or service contract data using the selection menu 212 of FIGS. 2 and 3. If the user selects to view warranty data (408 Warranties), the process 400 continues to act 410. If the user selects to view service contracts (408 Service Contracts), the process 400 continues to act 412. Other options may also be available to the user.

At act 410, the interface may display information related to warranties to the user. For example, the user interface 300 of FIG. 3 may be displayed to the user. The user may use the interface to perform any function or manipulation of the data described herein, including with respect to FIG. 3.

At act 412, the interface may display information related to service contracts to the user. For example, the user interface 200 of FIG. 2 may be displayed to the user. The user may use the interface to perform any function or manipulation of the data described herein, including with respect to FIG. 2.

In some examples disclosed herein, not all relevant data may be available automatically at the point-of-sale system (for example, the point-of-sale system 102 of FIG. 1). In such cases, the customer may be enabled to use the user interface (for example, user interface 108 of FIG. 1) to input any missing data manually.

In some examples disclosed herein, the database 106 may be periodically updated and/or may be cross-referenced against other databases (such as an external database) to populate the database 106 with additional data.

In some examples disclosed herein, the system (for example, system 100) may provide the user with the ability to export the device list in a desired format, for example as a spreadsheet.

In some examples, the device list may display one or more warranty or service contract expiration dates. In examples where a device is subject to multiple warranties and/or service contracts, the device list may display the date of the soonest expiring warranty, latest expiring warranty, or any other warranty according to the user's inputs and/or preference. In some examples, an indication of a date gap between warranties or service contracts may also be provided. In some examples, the latest expiring date is displayed unless there is a gap between two consecutive warranties, in which case the expiration data immediately before the gap may be displayed. In some examples, for service contracts, the closest expiring service contract date may be displayed.

In some examples, the database may not permit manual override or changing of data by the customer when the data was automatically populated. In some examples, manually input data may be identified by a marker, for example, a symbol, a unique font color, and so forth.

As used herein, the term “user” does not necessarily refer to a person or organization, though these meanings are encompassed by the term “user.” “User” may also refer to any process or entity used to interact with the data related to the devices and maintenance agreements (e.g., the data stored in the database). For example, a user may be an automated program that is configured to interact with the database 106 and/or a device used to interact with the database 106.

As used herein, the term “subset” does not necessarily mean a set comprising fewer elements than the total number of elements. For example, while a subset of devices, warranties, service contracts, or otherwise, may refer to fewer than all devices, warranties, or service contracts, it may also refer to an empty set (that contains no items) or every item. Thus, the subset of devices, as an example, may encompass anywhere from no devices to every device. This is because a filter option may apply to every device, for example, when a given filter option is selected all devices continue to meet the requirements of the filter option, and thus the subset is the full set of every device.

Examples of the methods and systems discussed herein are not limited in application to the details of construction and the arrangement of components set forth in the description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Various controllers, such as the management module 107 and/or data aggregator 104, may execute various operations discussed above. Using data stored in associated memory and/or storage, the controllers also execute one or more instructions stored on one or more non-transitory computer-readable media, which the controllers may include and/or be coupled to, that may result in manipulated data. In some examples, the controllers may include one or more processors or other types of controllers. In one example, the controllers are or include at least one processor. In another example, the controllers perform at least a portion of the operations discussed above using an application-specific integrated circuit tailored to perform particular operations in addition to, or in lieu of, a general-purpose processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Having thus described several aspects of at least one embodiment, it is to be appreciated that various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

Further examples are the following clauses:

Clause 1: A system for managing maintenance agreements, including: a management module configured to: identify one or more devices, retrieve maintenance agreement information from a database, provide, via a user interface, a list of the one or more devices, and provide, via the user interface, a respective maintenance agreement status associated with each device of the one or more devices, the respective maintenance agreement status being based the maintenance agreement information and on whether a respective device of the one or more devices is associated with a maintenance agreement.

Clause 2: The system of clause 1 wherein the management module is configured to provide, via the user interface, one or more filter options to the user, and, responsive to receiving a request to filter the list, providing a portion of the list limited to a subset of the one or more devices, the subset corresponding to the request to filter the list.

Clause 3: The system of clause 1 wherein the management module is configured to provide analytic data via the user interface, the analytic data corresponding to the one or more devices and to the respective maintenance agreement status of each device.

Clause 4: The system of clause 1 or 3 wherein the analytic data includes at least three classifications including a first classification of devices covered by a maintenance agreement expiring in a predetermined number of days or more, a second classification of devices covered by a maintenance agreement expiring in less then the predetermined number of days, and a third classification of devices not covered by an active maintenance agreement.

Clause 5: The system of clause 1, 3, or 4 wherein the analytic data is displayed using at least a graph showing one or more respective visual representations of relative percentages of devices covered by the first classification, the second classification, and the third classification.

Clause 6: The system of clause 1, 3, 4, or 5 wherein each respective visual representation of the one or more respective visual representations is configured to, when interacted with by a user, display a numeric representation of a respective percentage corresponding to the respective visual representation.

Clause 7: The system of clause 1 further including a data aggregator configured to receive one or more identities of one or more devices from a point-of-sale system, and to associate respective identities of the one or more devices with one or more maintenance agreements covering respective devices to which the one or more identities correspond.

Clause 8: The system of clause 1 wherein the management module is further configured to receive requests from a user to store previously unobtained data in a database and, responsive to receiving the requests, to store at least a portion of the previously unobtained data.

Clause 9: A method of managing warranties and service contracts, including: identifying one or more devices; providing, via a user interface, a list of the one or more devices; responsive to receiving a request to filter the list, providing a portion of the list limited to a subset of the one or more devices, the subset corresponding to the request to filter the list; and providing, via the user interface, a respective maintenance agreement status associated with each device of the one or more devices, the respective maintenance agreement status being based on whether a respective device of the one or more devices is associated with a maintenance agreement.

Clause 10: The method of clause 9 further including providing, via the user interface, analytic data about the one or more devices.

Clause 11: The method of clause 9 or 10 wherein the analytic data includes at least three classifications including a first classification, a second classification, and a third classification, the first classification corresponding to devices covered by a maintenance agreement expiring in a predetermined number of days or more, the second classification corresponding to devices covered by a maintenance agreement expiring in less than the predetermined number of days, and the third classification corresponding to devices not currently covered by an active maintenance agreement.

Clause 12: The method of clause 9, 10, or 11 wherein the analytic data is displayed using at least a graph showing one or more respective visual representations of relative percentages of the first classification, the second classification, and the third classification.

Clause 13: The method of clause 9, 10, 11, or 12 wherein each respective visual representation of the one or more respective visual representations is configured to, when interacted with by a user, display a numeric representation of a respective percentage corresponding to the respective visual representation.

Clause 14: The method of clause 9 wherein the maintenance agreement status includes at least one of an expiration date of at least one non-expired maintenance agreement associated with at least one device of the one or more devices, or an indication that no maintenance agreement applies to the at least one device.

Clause 15: The method of clause 9 wherein providing the respective maintenance agreement status includes displaying, via the user interface, maintenance agreement statuses of the subset of the one or more devices responsive to receiving the request to filter the list.

Clause 16: The method of clause 9 wherein identifying the one or more devices includes identifying the one or more devices at a point-of-sale system; and the method further comprises, responsive to identifying the one or more devices, associating the one or more devices with at least one maintenance agreement of the one or more maintenance agreements.

Clause 17: The method of clause 9, further including storing the list of one or more devices in a database, wherein the database contains information about the one or more maintenance agreements associated with the one or more devices.

Clause 18: The method of clause 9, wherein the request to filter the list includes requesting to filter the list based on at least one of a location, a type of maintenance agreement, a status of a maintenance agreement, a manufacturer of a device, and/or a type of device.

Clause 19: The method of clause 9, wherein the one or more maintenance agreements include at least one of warranties and/or service contracts.

Clause 20: A non-transitory computer-readable medium containing thereon instructions for managing maintenance agreement data, the instructions, when executed, causing at least one processor to: identify one or more devices; display, via a user interface, a list of the one or more devices; display one or more filters; responsive to receiving a filter request based on the one or more filters, displaying a subset of the list on the user interface, the subset corresponding to the filter request; and display, via the user interface, a respective maintenance agreement status associated with each device of the one or more devices, the respective maintenance agreement status being based on whether a respective device of the one or more devices is associated with a maintenance agreement.

Clause 21: The non-transitory computer-readable medium of clause 20 wherein the maintenance agreement status includes at least one of an expiration data of a non-expired maintenance agreement associated with at least one device of the one or more devices, or an indication that no maintenance agreement applies to the at least one device.

Clause 22: The non-transitory computer-readable medium of clause 20 wherein the instructions further cause the at least one processor to: identify the one or more devices at a point-of-sale; transmit at least one identity of the one or more devices to a database; associate the at least one identity of the one or more devices with the one or more maintenance agreements in the database or indicate that no maintenance agreement applies to the one or more devices corresponding to the at least one identity.

Clause 23: The non-transitory computer-readable medium of clause 20 wherein the instructions further cause the at least one processor to display, via the user interface, analytics corresponding the one or more devices and the one or more maintenance agreements, the analytics being displayed using at least a graph showing one or more respective visual representations of relative percentages of devices covered by a maintenance agreement expiring in a predetermined number of days or more, devices covered by a maintenance agreement expiring in less than the predetermined number of days, and devices not covered by an active maintenance agreement with respect to all devices of the one or more devices, and each respective visual representation of the one or more respective visual representations, responsive to being interacted with by a user, causes display of a numeric representation of a respective percentage corresponding to the respective visual representation.

Clause 24: A non-transitory computer-readable medium containing thereon instructions for managing maintenance agreement data, the instructions, when executed, causing at least one processor to identify one or more devices and to display, via a user interface, a list of the one or more devices, and to display one or more filters, and to, responsive to receiving a filter request based on the one or more filters, displaying a subset of the list on the user interface, the subset corresponding to the filter request; and display, via the user interface, a respective maintenance agreement status associated with each device of the one or more devices, the respective maintenance agreement status being based on whether a respective device of the one or more devices is associated with a maintenance agreement.

Clause 25: The non-transitory computer-readable medium of clause 20, wherein the analytics include at least a percentage of the one or more devices covered by a maintenance agreement compared to a total number of the one or more devices.

Clause 26: The non-transitory computer-readable medium of clause 20, wherein displaying the list includes selecting, prior to displaying the list, between service agreements and warranties, and displaying the list with respect to one of the service agreements or warranties based on the selection.

Clause 27: The non-transitory computer-readable medium of clause 20 wherein the one or more filters includes options to filter by at least one of a location, a type of maintenance agreement, a status of a maintenance agreement, a manufacturer of a device, or a type of device.

Clause 28: The non-transitory computer-readable medium of clause 20, wherein the one or more maintenance agreements include at least one of warranties and/or service agreements.

What is claimed is:

1. A system for managing maintenance agreements, comprising:
a management module configured to:
identify one or more devices,
retrieve maintenance agreement information from a database,
provide, via a user interface, a list of the one or more devices, and
provide, via the user interface, a respective maintenance agreement status associated with each device of the one or more devices, the respective maintenance agreement status being based the maintenance agreement information and on whether a respective device of the one or more devices is associated with a maintenance agreement.

2. The system of claim 1 wherein the management module is configured to provide, via the user interface, one or more filter options to the user, and, responsive to receiving a request to filter the list, providing a portion of the list limited to a subset of the one or more devices, the subset corresponding to the request to filter the list.

3. The system of claim 1 wherein, the management module is configured to provide analytic data via the user interface, the analytic data corresponding to the one or more devices and to the respective maintenance agreement status of each device.

4. The system of claim 3 wherein the analytic data includes at least three classifications including a first classification of devices covered by a maintenance agreement expiring in a predetermined number of days or more, a second classification of devices covered by a maintenance agreement expiring in less then the predetermined number of days, and a third classification of devices not covered by an active maintenance agreement.

5. The system of claim 4 wherein the analytic data is displayed using at least a graph showing one or more respective visual representations of relative percentages of devices covered by the first classification, the second classification, and the third classification.

6. The system of claim 5 wherein each respective visual representation of the one or more respective visual representations is configured to, when interacted with by a user, display a numeric representation of a respective percentage corresponding to the respective visual representation.

7. The system of claim 1 further comprising a data aggregator configured to receive one or more identities of one or more devices from a point-of-sale system, and to associate respective identities of the one or more devices with one or more maintenance agreements covering respective devices to which the one or more identities correspond.

8. The system of claim 1 wherein the management module is further configured to receive requests from a user to store previously unobtained data in a database and, responsive to receiving the requests, to store at least a portion of the previously unobtained data.

9. A method of managing warranties and service contracts, comprising:
identifying one or more devices;
providing, via a user interface, a list of the one or more devices;
responsive to receiving a request to filter the list, providing a portion of the list limited to a subset of the one or more devices, the subset corresponding to the request to filter the list; and
providing, via the user interface, a respective maintenance agreement status associated with each device of the one or more devices, the respective maintenance agreement status being based on whether a respective device of the one or more devices is associated with a maintenance agreement.

10. The method of claim 9 further comprising providing, via the user interface, analytic data about the one or more devices.

11. The method of claim 10 wherein the analytic data includes at least three classifications including a first classification, a second classification, and a third classification, the first classification corresponding to devices covered by a maintenance agreement expiring in a predetermined number of days or more, the second classification corresponding to devices covered by a maintenance agreement expiring in less than the predetermined number of days, and the third classification corresponding to devices not currently covered by an active maintenance agreement.

12. The method of claim 11 wherein the analytic data is displayed using at least a graph showing one or more respective visual representations of relative percentages of the first classification, the second classification, and the third classification.

13. The method of claim 12 wherein each respective visual representation of the one or more respective visual representations is configured to, when interacted with by a user, display a numeric representation of a respective percentage corresponding to the respective visual representation.

14. The method of claim 9 wherein the maintenance agreement status includes at least one of an expiration date of at least one non-expired maintenance agreement associated with at least one device of the one or more devices, or an indication that no maintenance agreement applies to the at least one device.

15. The method of claim 9 wherein providing the respective maintenance agreement status includes displaying, via the user interface, maintenance agreement statuses of the subset of the one or more devices responsive to receiving the request to filter the list.

16. The method of claim 9 wherein identifying the one or more devices includes identifying the one or more devices at a point-of-sale system; and the method further comprises, responsive to identifying the one or more devices, associating the one or more devices with at least one maintenance agreement of the one or more maintenance agreements.

17. A non-transitory computer-readable medium containing thereon instructions for managing maintenance agreement data, the instructions, when executed, causing at least one processor to:
identify one or more devices;
display, via a user interface, a list of the one or more devices;
display one or more filters;
responsive to receiving a filter request based on the one or more filters, displaying a subset of the list on the user interface, the subset corresponding to the filter request; and
display, via the user interface, a respective maintenance agreement status associated with each device of the one or more devices, the respective maintenance agreement status being based on whether a respective device of the one or more devices is associated with a maintenance agreement.

18. The non-transitory computer-readable medium of claim 17, wherein the maintenance agreement status includes at least one of an expiration data of a non-expired maintenance agreement associated with at least one device of the one or more devices, or an indication that no maintenance agreement applies to the at least one device.

19. The non-transitory computer-readable medium of claim 17 wherein the instructions further cause the at least one processor to:
identify the one or more devices at a point-of-sale;
transmit at least one identity of the one or more devices to a database;
associate the at least one identity of the one or more devices with the one or more maintenance agreements in the database or indicate that no maintenance agreement applies to the one or more devices corresponding to the at least one identity.

20. The non-transitory computer-readable medium of claim 17 wherein the instructions further cause the at least one processor to display, via the user interface, analytics corresponding the one or more devices and the one or more maintenance agreements, the analytics being displayed using at least a graph showing one or more respective visual representations of relative percentages of devices covered by a maintenance agreement expiring in a predetermined number of days or more, devices covered by a maintenance agreement expiring in less than the predetermined number of days, and devices not covered by an active maintenance agreement with respect to all devices of the one or more devices, and each respective visual representation of the one or more respective visual representations, responsive to being interacted with by a user, causes display of a numeric representation of a respective percentage corresponding to the respective visual representation.
